(19) United States
(12) Patent Application Publication
(10) Pub. No.: US 2008/0124505 A1
(43) Pub. Date: May 29, 2008

(54) Filter Grid Cover

(75) Inventors: Noah Nichols, Ringgold, GA (US); Ralph Alan Sutton, Gainesville, GA (US)

Correspondence Address: KING & SPALDING LLP, 1180 PEACHTREE STREET, ATLANTA, GA, 30309-3521, US

(73) Assignee: Propex Inc., Chattanooga, TN (US)

(21) Appl. No.: 11/946,240

(22) Filed: Nov. 28, 2007

Related U.S. Application Data
(60) Provisional application No. 60/867,524, filed on Nov. 28, 2006.

(51) Int. Cl. B32B 1/08; B32B 3/00; B29D 28/00

(52) U.S. Cl. 428/36.1; 428/58; 264/103

(57) ABSTRACT

A fabric filter cover sleeve woven on a flat loom in a manner allows a section of the fabric, having a specified width, to be opened up similar to a tube, sleeve or bag. Several of the tubes (or sleeves, or bags) may be woven on the loom simultaneously. The tubes may be continuous or closed on either or both end in a specified length. For example, a tube closed at one end may be considered a bag shaped filter cover. The fabric filter cover sleeves may be woven of various types of natural and synthetic yarns, such as extruded thermoplastic yarns. The woven fabric filter covers can be easily separated such that each sleeve can enclose, or cover, structures used within filters. Filter structures, such as filter grids, or filtration materials, such as diatomaceous earth, or sand, may be enclosed within the woven fabric sleeves to form filters.

### CROSS REFERENCE TO RELATED APPLICATION FOR WHICH A BENEFIT IS CLAIMED UNDER 35 U.S.C. §119(e)

This patent application claims priority under 35 U.S.C. §119(e) to U.S. Provisional Patent Application No. 60/867,524, entitled “Filter Grid Cover,” filed Nov. 28, 2006. The complete disclosure of the above-identified priority application is hereby fully incorporated herein by reference.

### FIELD OF THE INVENTION

Broadly, this invention relates to manufacturing a fabric for use in covering a filter and more specifically to weaving the fabric for the cover so as to reduce or remove the need for additional steps in sewing or sealing one or more seams of a filter cover.

### BACKGROUND

Filters are generally used to remove unwanted particles from water, air, or other fluids. One common application for filters is in swimming pool water. Filters may include a cover, outer membrane, or outside layer. The filter cover may itself contribute to the filtering function by blocking the passage of particles larger than the openings within the material of the filter cover. The filter cover may also serve the purpose of an enclosure for the filtering material. As an enclosure, of sorts, the filter cover may serve to maintain the filtering material to its appropriate location, shape, distribution, or density within the filter cover.

Filter cover are typically woven fabrics. These fabrics are generally woven in a flat sheet. These sheets can be sold to filter fabricators who cut and form the flat sheet into a rectangular cover. The rectangular cover can be formed into a bag shape in which two or three sides are sewn, or sealed, together. The bag shaped rectangular cover is generally placed over a grid or leaf. This assembly then requires additional sewing, or sealing, to close the remaining edge or edges of the filter cover. This results in a covered filter, or filter section, through which the filtrate passes to be filtered. Alternatively, buttons, zippers or other mechanisms are used to close the fabric edges around the filter.

In all of these cases, the additional step or steps of forming the filter cover fabric into bags or sleeves can add time, cost, material waste, and opportunity for error to the manufacturing process. Accordingly, there is a need in the art for a filter cover that can eliminate the sewing or sealing of one or two edges of the filter cover sleeve, or bag, by providing filter cover fabric that is pre-woven into a sleeve, or bag, structure.

### SUMMARY OF THE INVENTION

The present invention relates to woven fabric filter covers. The filter cover fabric can be woven on a flat loom in a manner that allows a section of the fabric, having a specified width, to be opened up similar to a tube, sleeve or bag. Depending upon the width of the loom and width of each fabric section, several of the tubes (or sleeves, or bags) may be woven on the loom simultaneously. For example, three, five, seven, or some other quantity may be woven simultaneously. The tubes may be continuous or closed on either or both end in a specified length. For example, a tube closed at one end may be considered a bag shaped filter cover. These tubes can be easily separated such that each tube can enclose, or cover, structures used within filters. Such a filter may be applied as a swimming pool filter.

Various types of natural and synthetic yarns may be used to form fabric filter cover sleeves or fabric filter cover bags. For example, polyolefin, polypropylene, polyamide, polyethylene, polyester, copolymer, nylon, or other materials may be used to weave the fabric filter cover sleeves or fabric filter cover bags. Since polypropylene is resistant to many chemicals and has a low cost, it is the often used in covers for diatomaceous earth pool filters.

Concerning the weaving of the filter cover fabric, the warp is the set of lengthwise yarns through which the weft is woven. In loom weaving, the warp yarns are fully attached before weaving begins. Each warp yarn within a fabric is called a warp end. The weft (also known as fill or filling) is the yarn that is shuttled back and forth across the warp to weave a fabric.

The discussion of woven fabric filter covers in this summary is for illustrative purposes only. Various aspects of the present invention may be more clearly understood and appreciated from a review of the following detailed description of the disclosed embodiments and by reference to the drawings and the claims that follow. Moreover, other aspects, systems, methods, features, advantages, and objects of the present invention will become apparent to one with skill in the art upon examination of the following drawings and detailed description. It is intended that all such aspects, systems, methods, features, advantages, and objects are included within this description, are within the scope of the present invention, and are protected by the accompanying claims.

### BRIEF DESCRIPTION OF THE DRAWINGS

FIG. 1 illustrates three woven filter cover tubes separated by selvages according to one exemplary embodiment of the invention.

FIG. 2 illustrates a cross sectional view near the selvage between two woven filter cover tubes according to one exemplary embodiment of the invention.

FIG. 3 illustrates a filter structure partially inserted into a woven filter cover tube according to one exemplary embodiment of the present invention.

FIG. 4 illustrates nine woven filter cover bags separated by selvages according to one exemplary embodiment of the invention.

FIG. 5 is a logical flow diagram of a process for manufacturing filter covers according to one exemplary embodiment of the present invention.

Many aspects of the invention will be better understood with reference to the above drawings. The elements and features shown in the drawings are not to scale, emphasis instead being placed upon clearly illustrating the principles of exemplary embodiments of the present invention. Moreover, certain dimensions may be exaggerated to help visually convey such principles. In the drawings, reference numerals designate like or corresponding, but not necessarily identical, elements throughout the several views.

### DETAILED DESCRIPTION OF EXEMPLARY EMBODIMENTS

The present invention relates to woven fabric filter covers. The filter cover fabric can be woven on a flat loom in a manner that allows a section of the fabric, having a specified width, to be opened up similar to a tube, sleeve or bag. Depending upon the width of the loom and width of each fabric section, several of the tubes (or sleeves, or bags) may be woven on the loom simultaneously. The tubes may be continuous or closed on one end to form a bag shaped filter cover. The tubes can be easily separated such that each tube can enclose, or cover, structures used within filters.

The fabric filter covers may be woven of various types of natural and synthetic yarns, such as extruded thermoplastic yarns, for example. Filter structures, such as filter grids, or filtration materials, such as diatomaceous earth, or sand, may be enclosed within the woven fabric tubes to form filters or segments of filters. The filters may be used to reduce unwanted particles from air, water, or some other fluid. Filters may also be used to recover desired particles that are suspended in a fluid.

The invention can be embodied in many different forms and should not be construed as limited to the embodiments set forth herein; rather, these embodiments are provided so that this disclosure will be thorough and complete, and will fully convey the scope of the invention to those having ordinary skill in the art. Furthermore, all “examples” or “exemplary embodiments” given herein are intended to be non-limiting, and among others supported by representations of the present invention.

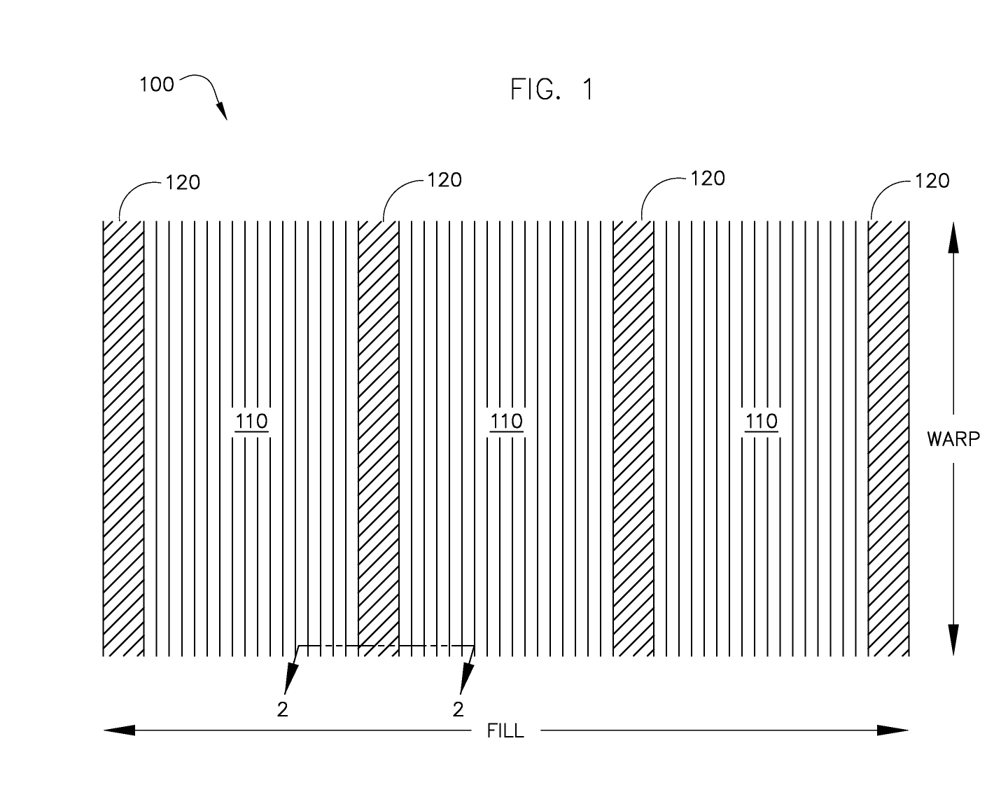

Turning now to FIG. 1, the figure illustrates a woven panel of fabric 100 containing three woven filter cover sleeves 110 separated by selvages 120 according to one exemplary embodiment of the invention. A selvage 120 can be woven as a single layer, while a woven filter cover sleeves 110 can have two layers of fabric. A selvage 120 serves as the closure on the sides of a woven filter cover sleeves 110 and reduces the need for sewing, or otherwise sealing, the final sleeve product. Each of the three woven filter cover sleeves 110 may be separated in order to form distinct covers for filter materials as used in filters, such as pool filters.

The woven filter cover sleeves 110 can be woven of various types of natural and synthetic yarns. For example, polyolefin, polypropylene, polyamide, polyethylene, polyester, copolymer, nylon, or other materials may be used to weave the fabric filter cover sleeves 110. Filter structures, such as filter grids, or filtration materials, such as diatomaceous earth, or sand, may be enclosed within the woven fabric sleeves 110 to form filters or segments of filters.

While the pattern of the filter cover sleeves 110 is illustrated in FIG. 1 as being tube-like to accommodate rectangular, or substantially rectangular filters, the shape can also be a circular, triangular, or any other shape, as examples. The construction of the woven filter cover sleeves 110 may have 20 to 600 warp ends per inch, where typical construction values range from 30 to 150 warp ends per inch.

The selvage 120 can be woven with the same, or different weave as the filter cover sleeve 110. The need for the fabric in the selvage 120 to be different from the fabric in the woven filter cover sleeve 110 may depend on the filter material, or filter structures, being placed within the woven filter cover sleeve 110.

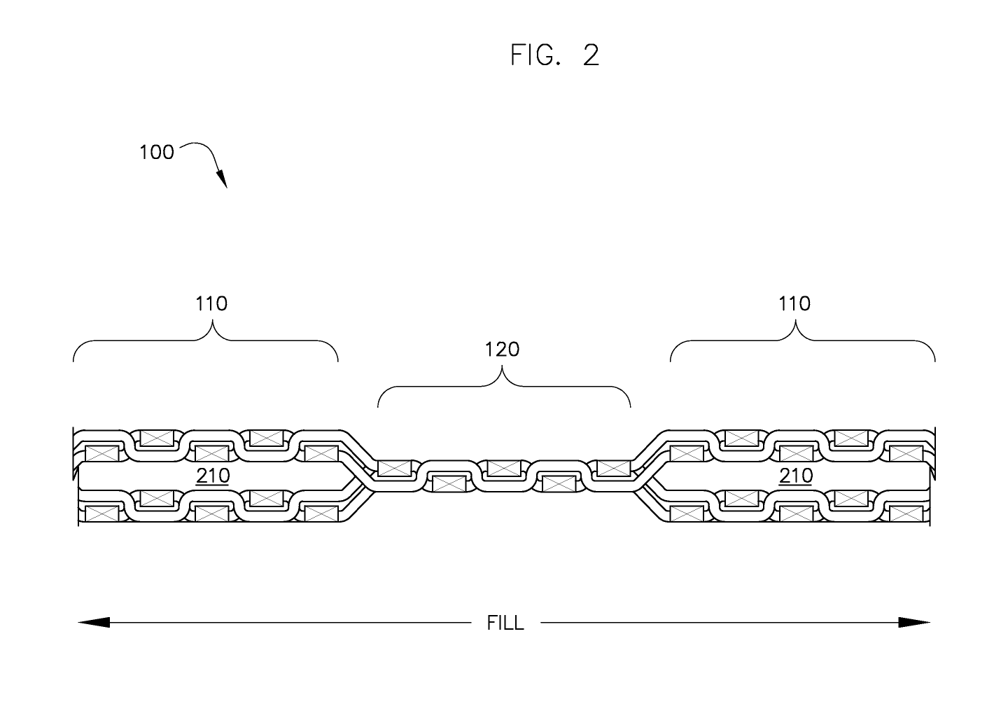

Turning now to FIG. 2, the figure illustrates a cross sectional view near the selvage 120 between two woven filter cover sleeves 110 according to one exemplary embodiment of the invention. The view is along cut-line 2-2 of FIG. 1. The view is from the warp direction and shows an exemplary weave where the same pattern may be used within the selvage 120 and in each layer of the woven filter cover sleeve 110. A void 210 between layers of the woven filter cover sleeve 110 defines the interior of the sleeve where filter structures and filter material can be placed when forming the filter element. The selvage 120 can have twice the number of picks as the sleeve layers 110 since picks for both of the layers of the woven filter cover sleeve 110 may be tied into the same selvage 120.

The weave construction of the woven panel 100 may have 20 to 600 warp ends per inch with typical construction ranging from 30 to 150 warp ends per inch. According to one exemplary embodiment, a woven filter cover sleeve 110 might have a machine construction of 54 warp ends per inch and 54 filling ends per inch in the selvage 120 corresponding to 54 warp ends per inch and 27 filling ends per inch within each layer of the woven filter cover sleeve 110.

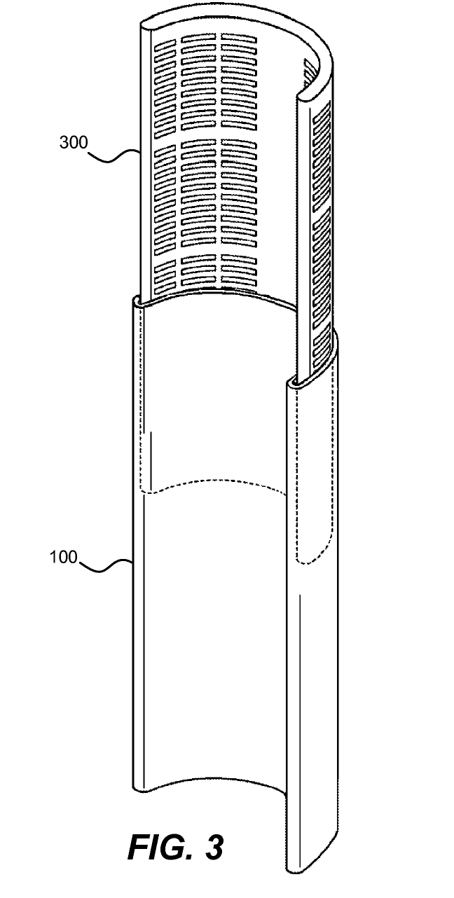

Turning now to FIG. 3, the figure illustrates a filter structure 300 partially inserted into a woven filter cover 100 according to one exemplary embodiment of the present invention. The filter structure 300 may be a filter grid, filter lattice, filter substrate, or any other filtering structure. Filtration materials, such as diatomaceous earth, sand, or any other filtering medium may also be inserted into the woven filter cover 100.

The filter cover fabric 100 can be woven having a specified width, to be opened up similar to a tube, sleeve or bag in order to accommodate the filter structure 300. The tubes may be continuous or closed on one end to form a bag shaped filter cover.

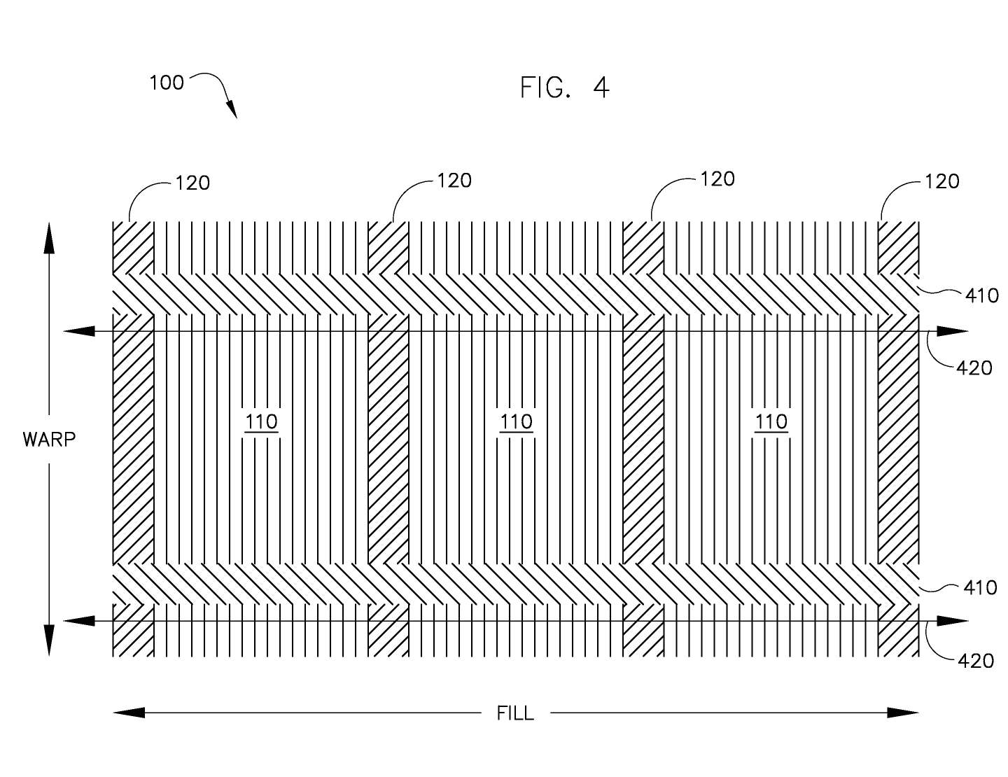

Turning now to FIG. 4, the figure illustrates a woven panel 400 containing nine woven filter cover sleeves 110 separated by selvages 120, 410 according to one exemplary embodiment of the invention. The selvage 120, 410 can be woven as a single layer, while a woven filter cover sleeve 110 can have two layers of fabric. The selvage 120 can serve as the closure on the sides of a woven filter cover sleeves 110. The selvage 410 can serve as the closure on the top and/or bottom of a woven filter cover sleeve 110, thus forming a bag shaped woven filter cover sleeve 110. The pre-woven selvages 410 may reduce the need for sewing, or otherwise sealing, the final sleeve product.

Each of the nine woven filter cover sleeves 110 may be separated in order to form distinct covers for filter materials as used in filters, such as pool filters. Separating the woven filter cover sleeves 110 along cut line 420 can leave one end of the sleeve 410 open and one end sealed. The woven filter cover sleeves 110 may be processed continuasly as the cross selvage 410 weaves filter cover 110 closed and a cut along the cut line 420 opens up the next cover 110.

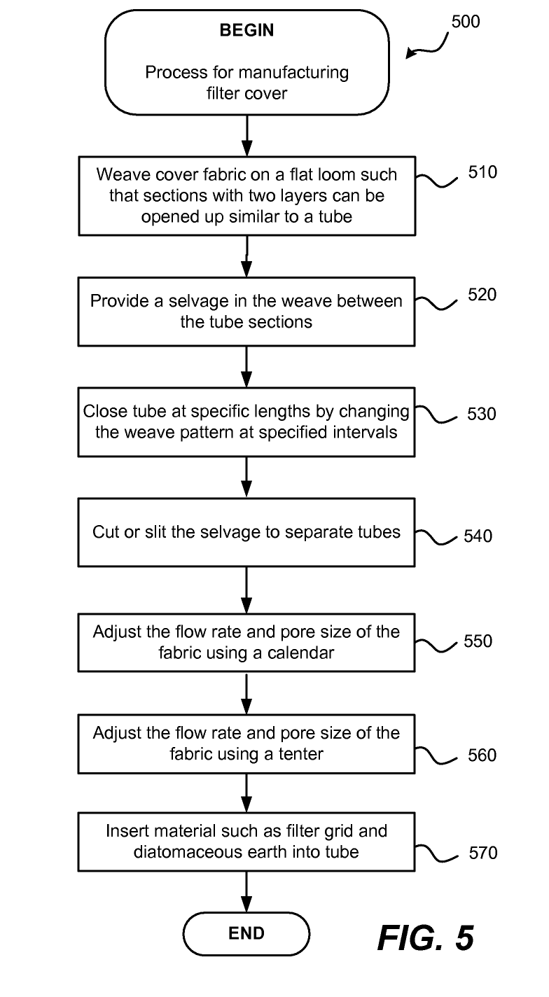

Turning now to FIG. 5, the figure is a logical flow diagram of a process 500 for manufacturing filter covers according to one exemplary embodiment of the present invention. Certain steps in the processes or process flow described in the logic flow diagram referred to hereinafter naturally precede others for the invention to function as described. However, the invention is not limited to the order of the steps described if such order or sequence does not alter the functionality of the invention. That is, it is recognized that some steps may be performed before, after, or in parallel with other steps without departing from the scope or spirit of the invention.

Beginning at Step 510, cover fabric 100 can be woven on a flat loom such that woven filter cover sleeves 110 with two layers can be opened up similar to a tube. In Step 520, a selvage 120 can be provided in the weave between the woven filter cover sleeves 110. Utilizing different weave patterns on the loom, a woven filter cover sleeve 110 can be formed that is closed up on both sides in the machine direction. This type of weaving can create an open tube shaped filter cover sleeve 110. A selvage 120 between the woven filter cover sleeves 110 may contain material that forms a closure along the sides of the woven filter cover sleeve 110. The woven filter cover sleeve 110 can be woven with a specific weave that will perform well in the application as a filter cover. Examples of the weaves that may be used are plain, twill, satin, oxford or various other weaves including variations or combinations of the listed examples. A single sleeve can be woven at a time. Also, multiple sleeves can be woven simultaneously depending on the loom width and the width of each sleeve.

In Step 530, a woven filter cover sleeve 110 can be closed at specific lengths by changing the weave pattern at specific intervals to create cross selvages 410 within the fabric 400. A mechanical or computer controlled dobby head can be employed on the loom to weave such cross selvages. Step 530 may be used to form bag-like woven filter cover sleeves 110 that are closed on three sides, for example. Alternatively, Step 530 may be excluded to form tube-like woven filter cover sleeves 110 that are closed on only two sides, and do not include cross closures from a cross selvage 410.

In Step 540, the selvage 120 can be either slit, or cut, to separate the woven filter cover sleeves 110. Such cutting or slitting can take place within selvage 120 and/or adjacent to selvage 410 along cut line 420. The cutting or slitting can be performed ultrasonically, by hot knife, or by various other cutting means.

In Step 550, the flow rate through the fabric 100, 400 can be adjusted using a calendar machine to adjust the pore size of the fabric 100, 400. The amount of material woven into the fabric 100, 400 can determine the air or water flow and pore size of the openings in the fabric. However, a fabric may not meet the targeted air flow requirement, or water flow requirement, or pore size requirement right off the loom. For example, a diatomaceous earth pool filter fabric can have a targeted air flow of 35-40 CFM and mean pore size of 30 microns.

A calendar machine can use heat and pressure to crush the fabrics to for specific opening sizes and corresponding specific slow rates. A calendar machine typically consists of two steel rollers heated with oil, electric coils or steam that are positioned above and below a fiber roll. The steel rollers can be hydraulically controlled to apply varying degrees of pressure on the fabric depending on the desired compression.

In Step 560, the flow rate through the fabric 100, 400 can be adjusted using a tenter machine. A tenter is a large oven (normally gas fired) that can be used to heat the fabric 100, 400. This heating can enable the fabric to be pulled. Pulling the fabric can serve to open the fabric up thus increasing opening size, or alternatively to shrink the fabric to close up the opening size. The tenter machine can hold, and manipulate, while it is processed through the oven.

In Step 570, filter inserts 300 and other filter material can be formed within the woven fabric filter sleeve 110. After the woven fabric filter sleeves 110 are cut to the length needed to cover a grid 300 or leaf on the filter system, filter structures and filter material can be enclosed within the filter cover 110. Filter structures, such as filter grids 300, or filtration materials, such as diatomaceous earth, or sand, may be enclosed within the woven fabric tubes to form filters or segments of filters. The filters may be used to reduce unwanted particles from air, water, or some other fluid. Filters may also be used to recover desired particles that are suspended in a fluid.

From the foregoing, it will be appreciated that an embodiment of the present invention overcomes the limitations of the prior art. Those skilled in the art will appreciate that the present invention is not limited to any specifically discussed application and that the embodiments described herein are illustrative and not restrictive. From the description of the exemplary embodiments, equivalents of the elements shown therein will suggest themselves to those skilled in the art, and ways of constructing other embodiments of the present invention will suggest themselves to practitioners of the art. Therefore, the present invention is to be provided the scope set forth by the claims that follow.

What is claimed is:

1. A woven filter cover sleeve comprising:
a first woven filter cover surface comprising a first edge;
a second woven filter cover surface comprising a second edge; and
a selvage adjacent to the first edge, and adjacent to the second edge, and woven into the first edge and the second edge as to close the first edge and the second edge together,
wherein the first woven filter cover surface, the second woven filter cover surface, and the selvage are formed together as a single weave.

2. The woven filter cover sleeve of claim 1, wherein the first woven filter cover surface, the second woven filter cover surface, and the selvage are each woven from thermoplastic yarn.

3. The woven filter cover sleeve of claim 1, wherein the first woven filter cover surface, the second woven filter cover surface, and the selvage each comprise polypropylene.

4. The woven filter cover sleeve of claim 1, wherein the woven filter cover sleeve is formed as a continuous tube structure.

5. A woven filter cover bag comprising:
a first woven filter cover surface comprising a first edge and a second edge adjacent to the first edge;
a second woven filter cover surface comprising a third edge and a fourth edge adjacent to the third edge;
a selvage adjacent to the first edge, and adjacent to the third edge, and woven into the first edge and the third edge as to close the first edge and the third edge together; and
a cross selvage perpendicular to the selvage, and adjacent to the second edge, and adjacent to the fourth edge, and woven into the second edge and the fourth edge as to close the second edge and the fourth edge together,
wherein the first woven filter cover surface, the second woven filter cover surface, the selvage, and the cross selvage are formed together as a single weave.

6. The woven filter cover sleeve of claim 5, wherein the first woven filter cover surface, the second woven filter cover surface, the selvage, and the cross selvage are each woven from thermoplastic yarn.

7. The woven filter cover sleeve of claim 5, wherein the first woven filter cover surface, the second woven filter cover surface, the selvage, and the cross selvage each comprise polypropylene.

8. A panel of woven filter cover fabric comprising:
a plurality of two layer sleeves operable as filter covers; and
a plurality of single layer selvages between the respective two layer sleeves,
wherein an edge of each two layer sleeve is woven into an adjacent single layer selvage as to close the edge of the layer sleeve.

9. The panel of woven filter cover fabric of claim 8, wherein the panel of woven filter cover fabric is woven from thermoplastic yarn.

10. The panel of woven filter cover fabric of claim 8, wherein the panel of woven filter cover fabric comprises polypropylene.

11. The panel of woven filter cover fabric of claim 8, wherein the plurality of two layer sleeves are formed as continuous tube structures.

12. A process for manufacturing woven fabric filter covers, comprising the steps of:
weaving a filter cover fabric comprising sections having two layers, and operable to be opened up similar to a tube;
providing a selvage in the weave between the sections;
cutting the selvage to separate the sections; and
inserting filter material into each of the sections.

13. The process of claim 12, further comprising the step of closing each of the sections at specific lengths by changing the weave pattern to form a cross selvage.

14. The process of claim 12, further comprising the step of adjusting the flow rate and pore size of the filter cover fabric using a calendar machines.

15. The process of claim 12, further comprising the step of adjusting the flow rate and pore size of the filter cover fabric using a tenter machines.

16. The process of claim 12, wherein the step of inserting filter material into each of the sections comprises inserting a filter grid into each of the sections.

17. The process of claim 12, wherein the step of inserting filter material into each of the sections comprises inserting diatomaceous earth into each of the sections.
